(19) United States
(12) Patent Application Publication
(10) Pub. No.: US 2014/0344170 A1
(43) Pub. Date: Nov. 20, 2014

(54) Publishing Personalized Documents on a Secondary Market

(71) Applicant: Chegg, Inc., Santa Clara, CA (US)

(72) Inventors: Vincent Le Chevalier, San Jose, CA (US); Charles F. Geiger, San Jose, CA (US)

(73) Assignee: Chegg, Inc., Santa Clara, CA (US)

(21) Appl. No.: 13/897,225

(22) Filed: May 17, 2013

(51) Int. Cl. G06Q 50/18; G06Q 30/00

(52) U.S. Cl. CPC G06Q 50/184; G06Q 30/018
USPC 705/310

(57) ABSTRACT

Embodiments provide a method and system to publish personalized documents to a secondary market within a digital publishing platform. The personalized document includes multiple layers of content from a foundation document and user-generated content. License conditions for the personalized document are bounded by the license for the foundation document and further limited by the user-specified license for the user-generated content. Once the personalized document is published, other users may order and access it based on the license properties of the personalized document.

### BACKGROUND

This invention relates to transferring of purchased licenses of multilayered digital documents between users of a digital publishing platform.

The successes of electronic book content offering and services have confirmed that readers at large were ready to migrate from print to digital content. Consumer adoption has been validated across a wide distribution of gender, age and geography as this shift accelerated all around the world. While the adaption rate of digital books has been impressive to current days, some readers have not switched yet from paper to digital books due to the fact that a number of limiting constraints remain to be addressed from both consumer and commerce perspectives. Noticeably, the commercial license properties of used digital assets is to date either non-existent or severely limited, resulting in a major difference in the inherent resale value of a printed book and its digital equivalent. To address this problem, technology companies have embraced the idea of secondary markets for reselling used digital assets in collaboration with publishers and other content owners.

However, as digital documents are shifting from a static model to a more dynamic model where related, personalized and social content are integrated with the original content and turned into multilayered digital publications, the definition of what constitutes a used digital asset needs to be adjusted and its commercial license properties revisited accordingly. Specifically in the education domain, textbooks and other teaching material often get enhanced over time by its readers, such as students, instructors and authors, through updating, notes taking, and other form of creations of user generated content. Furthermore, the rapid shift to mobile Internet services brings content offerings to an increasingly larger number of connected user devices. Digital publishing services previously limited to a single computer are now extended to multiple consumer electronic devices, such as smart phones, tablets, eReaders, game systems, and Internet TVs, which have become new channels to order and receive these services. Therefore, as digital publishing shifts the more dynamic model, which incorporates multilayered user-generated and social content within a digital document, the publishing services have to manage and distribute these new content layers across a plurality of mobile devices.

### SUMMARY

The goal of embodiments of the described method and system is to provide a system and method to users for publishing personalized documents on a secondary market within digital education and publishing platforms. Embodiments of the method and system leverage a digital publishing platform's overall digital document services and license management systems for digital content publication and redistribution.

The method and system facilitate publishing of personalized documents on a secondary market. In one embodiment, the digital publishing platform generates a personalized document comprising a foundation document combined with personalized content. The user-generated or personalized content can be aggregated into a structured UGC layer to supplement the original document in a foundation layer. The digital publishing platform then requests user-specified license properties for the personalized content from the publishing user. Subsequently, the digital publishing platform generates a secondary market license for the personalized document comprising primary market license for the foundation document and the user-specified license for the personalized content. After the personalized document is published for the secondary market, the digital publishing platform allows the personalized document to be ordered and accessed by other users.

### BRIEF DESCRIPTION OF THE DRAWINGS

FIG. 1 is a high-level block diagram illustrating a system environment for an educational digital content publication and reading platform according to one embodiment.

FIG. 2 is a block diagram illustrating an example user interface 200 of the eReading and notepad browser application comprising a plurality of windows for creating and storing user-generated content according to one embodiment.

FIG. 3 is a block diagram illustrating an example of multilayered document according to one embodiment.

FIGS. 4A-B are interaction diagrams illustrating the publishing of personalized documents on the digital publishing platform according to one embodiment.

FIG. 5 is a flowchart illustrating a method for publishing a personalized document to secondary market according to one embodiment.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

### Overview

Embodiments of the present invention provide a system and method for creating, commercializing and distributing personalized documents in markup language format on digital publishing platforms. The system is built upon an educational digital publishing and reading platform (hereinafter referred to as “the digital publishing platform” or “the platform”) configured to aggregate, manage, and distribute multilayered digital document. The digital document in modern markup language format can be accessed by general eReading browser applications (e.g., a HTML5 compatible browser) on a page by page basis and can be expanded to support a multilayered structure so as to incorporate supplemental content, such as dynamic listing of exercises and user-generated content in additional layers. By managing the transfer of purchased licenses between registered users, the digital publishing platform facilitates the resale of digital content that have been personalized by one or more users.

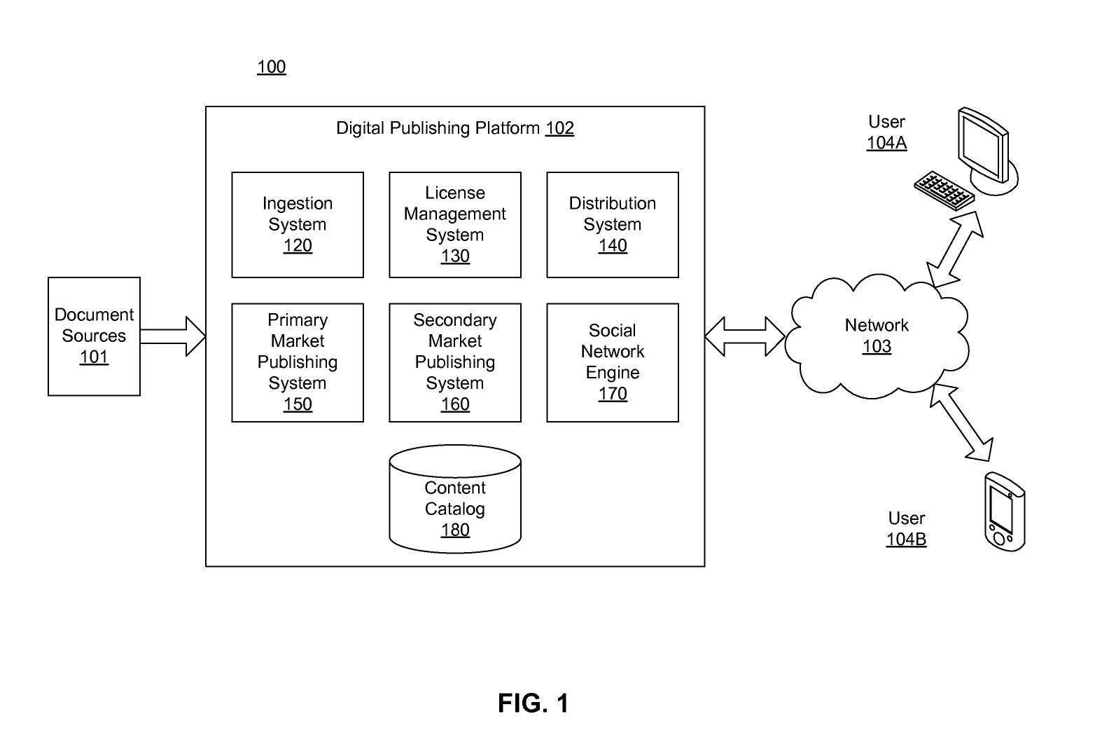

FIG. 1 is a high-level block diagram illustrating an environment 100 for the digital publishing platform, which comprises document sources 101, a digital publishing platform 102, a network 103, and a plurality of user devices 104A, 104B, collectively 104. The network 103 is typically a content delivery network (CDN) built on the Internet, but may include any network, including but not limited to a LAN, a MAN, a WAN, a mobile wired or wireless network, a private network, or a virtual private network. The user devices 104 access content reconstructed from the document sources 101 through eReading browser applications running on computing devices connected to the network 103. The user devices 104 include a personal computer, such as a desktop, laptop, or tablet computer, a personal digital assistant, a mobile or smart phone, or a television “set-top box” using a client web application.

In the digital publishing platform 102, each user is associated with an account on the digital publishing platform 102, and digital document purchased by the user through the digital publishing platform 102 is made available through the user account. In one embodiment, the user devices 104 may also be registered to the account to authorize the devices for accessing content services. Alternatively, the digital publishing platform 102 may establish an authenticated web session on a user device 104 when the user requests to access content of the digital publishing platform 102 from the user device 104. Furthermore, a user may access and interact with multilayered documents synchronously on a plurality of user devices 104. For example, the user may be reading a textbook using an eReading browser application on the user device 104A while taking notes on the user device 104B.

The document sources 101 include digital and printed content gathered and aggregated from a large number of publishers, categories, and partners. Examples of content include textbooks, trade books, magazines, newspapers, user-generated content, web content, and advertising content. Document content is automatically collected from various sources 101 into a formalized staging environment.

The digital publishing platform 102 aggregates, validates, transforms, packages, and monetizes the content collected by the source 101 into a number of services, prior to distribution to the user devices 104 over the network 103. The platform comprises a plurality of modules, such as an ingestion system 120, a license management system 130, a distribution system 140, a primary market publishing system 150, a secondary market publishing system 160, a social network engine 170, and a content catalog 180. Other embodiments may include more or fewer and/or different modules.

The ingestion system 120, including staging, validation, and normalization subsystems, ingests published documents that may be in a variety of different formats, such as PDF, ePUB2, ePUB3, SVG, XML, or HTML. The ingested document may be a book, such as a textbook, a set of self-published notes, or any other published documents, and may be subdivided in any manner. For example, the document may have a plurality of pages organized into chapters, which could be further divided into one or more sub-sections. Each page may have text, images, tables, graphs, or other items distributed across the page.

After ingestion, the documents are passed to the primary market publishing system 150. If the document ingested by the ingestion system 120 is not in a markup language format, the publishing system 130 automatically identifies, extracts, and indexes all the key elements and composition of the document to reconstruct it into a modern, flexible, and interactive markup language document, for example, an HTML5 web page well-suited for distribution across various computing devices. The transformed content preserves the original page structure including pagination, number of columns and arrangement of paragraphs, placement and appearance of graphics, titles and captions, and fonts used, regardless of the original format of the source content and complexity of the layout of the original document. In one embodiment, the primary market publishing system 130 reconstructs published documents so as to accommodate dynamic add-ons, such as related content, while maintaining page fidelity to the original document.

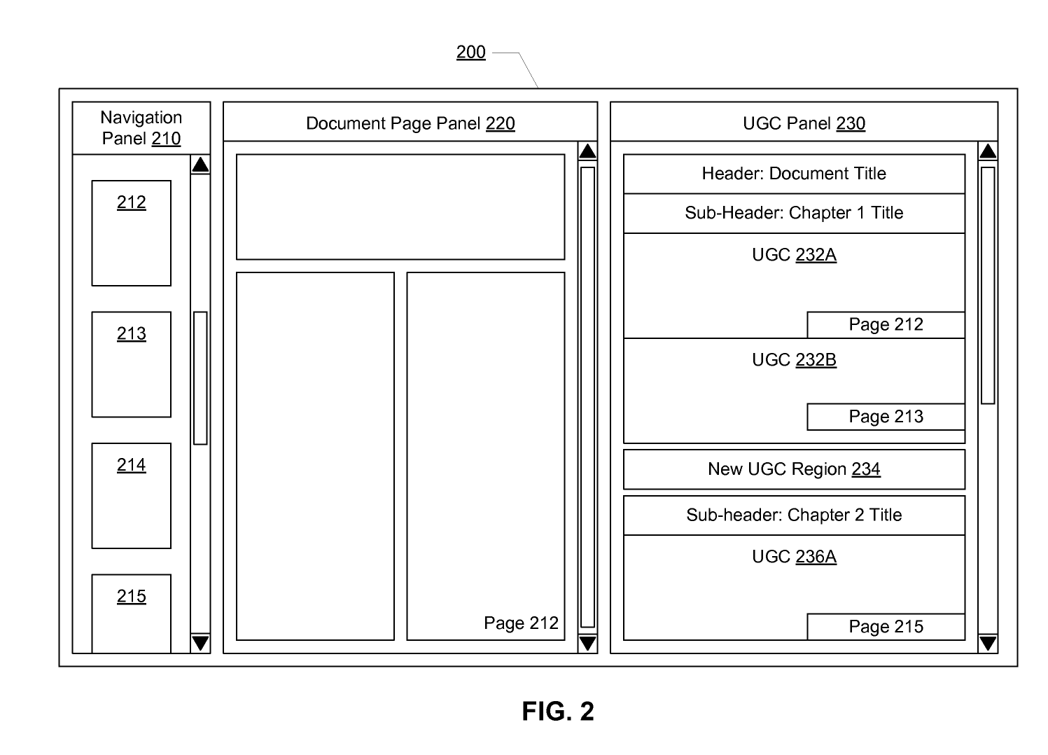

After reconstructing a document, the distribution system 140 packages content of the digital publishing platform 102 for delivery, uploads the content to content distribution networks, and makes the content available to end-users based on the content's digital rights management policies. The distribution system 140 may also aggregate additional content as layers on top of the foundation layer of original document from numerous sources. These layers, including related content, user-generated content, and advertising content, may be added to the document to create a dynamic, multilayered document. More details of the multilayered digital document are described with reference to FIG. 2 below.

The content catalog 180 is the central repository of all licensed content published by the digital publishing platform and commercialized via either a primary market publishing system 150 or secondary market publishing systems 160 to connected registered end-users. The primary content catalog is made of documents that have been initially reconstructed into markup language page-based services and which are accessed under license from registered end-users using connected devices with eReading browser applications, such as the HTML 5 compatible browsers. The secondary content catalog stores personalized content created by end-users while accessing licensed documents from their connected devices and incorporated into the multilayered documents dynamically.

The secondary market publishing system 160 manages orders and sales of personalized documents published in the secondary content catalog. A personalized document is a combination of the ingested markup language document constructed and published by the primary market publishing system 150 (i.e., foundation document) and user-generated or personalized content. In one embodiment, the personalized content is published as an associated user-generated content layer in the multilayered document. By combining the foundation document with the personalized content and integrating them into a distinct product offering, the digital publishing platform 102 opens a new secondary market for publishing personalized documents within the same platform.

The license management system 130 manages document licenses for both the primary market publishing system 150 and the secondary market publishing system 160. A document license contains a set of conditions or terms, referred to as license properties, under which a document may be distributed to others. The license properties may include pricing models, distribution markets, as well as types and levels of copy protection. The license management system 130 checks and validates license properties of the foundation document as well as UGC license properties. Generally, the content hosted within the primary content catalog is governed by license properties that are inherited from the owners of the content. For example, in the digital publishing platform 102, where ingested digital documents are reconstructed into dynamic multilayered structures, the license properties for a particular multilayered digital document are determined by the aggregation of the inherited license properties associated with each document layer.

The license properties for a foundation document reconstructed into markup language format also include transferred license properties that are related to terms and conditions for publishing and redistribution of the foundation document on the secondary market. For example, the transferred license properties can define whether or not the particular foundation document can be published to a secondary market with its remaining licensing period, the price and pricing model for publishing the foundation document on the secondary market, the authorized distribution areas or territories, and the types and levels of the content protection, among other properties that collectively govern the publishing and distribution of the document on the secondary market.

The license properties of the reconstructed markup language documents (referred to as the foundation documents) are inherited from the document owners (e.g., the author or the textbook publisher), while the UGC license properties are specified by the creating users of the UGC. The user-specified UGC license properties may also include sale price, pricing model, distribution markets, and/or other terms and conditions applicable to the secondary market. When publishing a personalized document on the secondary market publishing system, the license management system 130 and the secondary market publishing system 160 normalize the license properties across a spectrum of conditions, such as market areas, protections and pricing models from both licenses. For example, when a license property of the foundation document on the secondary market does not match or conflicts with a license property of the UGC layer on the secondary market, the more restrictive between the two conditions controls the distribution of the personalized document on the secondary market. The resulting normalized license properties govern the terms and conditions for the publishing and distribution of the personalized documents on the secondary market.

The social network engine 170 creates and manages an educational social network among users of the education digital publishing platform. For each individual user, the social network engine 170 automatically discovers and recommends social connections to the user based on user profile and other information about the user. Once connected through the education social network, users of the digital publishing platform 102 may interact with each other, for example, sharing user-generated content, commenting on classes, textbooks or exercises, and collaborating with each other on projects and activities.

Multilayered Document with User-Generated Content

A multilayered digital document comprises a foundation layer and one or more additional content layers. The foundation layer is a standalone document comprising one or more pages of the original document, ingested by the digital publishing platform and transformed into a markup language format while preserving the page fidelity. The one or more additional layers of the multilayered digital document include supplemental content, related content, and/or user-generated content associated with the pages of the foundation layer. The multilayered digital document represents services hosted by the digital publishing platform and is accessible by eReading browser applications executing on one or more connected user devices.

As a user reads and interacts with a document, the user may create, view, and organize personalized content or user-generated content (UGC), such as notes, by interacting with a notepad application executing on the user's device 104. In one embodiment, a user's eReading browser application is associated with a notepad application for the creation and organization of user-generated content. FIG. 2 is a block diagram illustrating an example user interface 200 of the eReading and notepad browser application comprising a plurality of windows for creating and storing user-generated content according to one embodiment. The user interface 200 includes a navigation panel 210, a document page panel 220, and a UGC panel 230.

After the user ordered the document, for example from the primary market publishing system 130, the user is granted a license to access the document. An authenticated eReading session is started for the user after providing a valid license and authentication information to the digital publishing platform. During the authenticated eReading session, the user may request to download one or more pages of the foundation document reconstructed by the digital publishing platform 102. The one or more pages requested by the user are downloaded to the user device 104 and rendered in the document page panel 220. The navigation panel 210 lists the table of contents of the document or a high-level summary of the table of contents, enabling the user to view an outline of the document structure. In one embodiment, a user can navigate through the document by clicking on links or icons within the navigation pane 210. For example, when the user clicks on a page with number “212,” the eReading application fetches the page from the digital publishing platform 102. Alternatively, one or more pages may be cached within the eReading browser application's memory on the device 104, in which case the eReading application 220 may retrieve a page from the browser's memory cache instead.

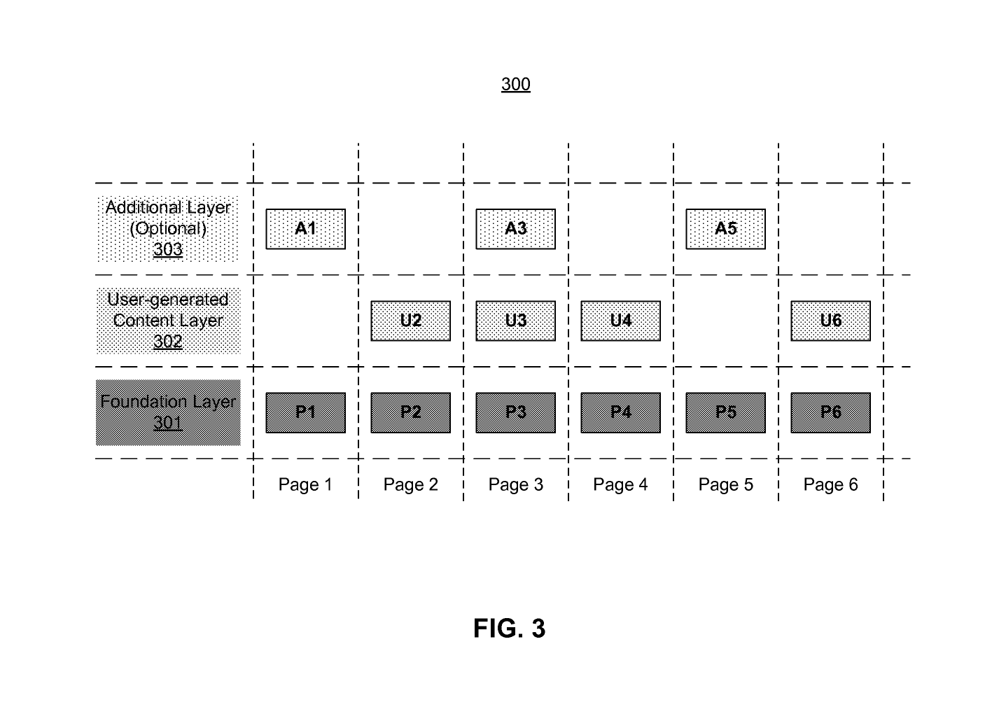

In one embodiment, the UGC panel 230 may be launched by a user during an eReading session, which is rendered alongside the document page panel 210 in the same browser window, as illustrated in FIG. 3. Alternatively, the UGC panel 230 may also integrate a wide screen mode that occupies the navigation pane 210 and the document page panel 220, for example, when a user clicks an “expand window” button or drags the UGC panel 230 to the right side of the screen. In yet another embodiment, a user may effectively separate the UGC panel 230 from the document page panel 220 by opening the notepad browser application on a different connected device that registered to the same user.

The UGC panel 230 may contain multiple fields, for example, a header and sub-header lists the title and sections of the opened multilayered document to which the entire UGC refer. The UGC panel 230 may also include one or more UGC windows, such as UGC windows 232A and 232B and new UGC region 232. A note window is a dynamically resizable box within the UGC panel 230 for either editing or displaying notes. The user notes 240 are notes already existing in the notepad beneath the sub-header 234. The new note windows 236 are empty boxes in which the user may create new notes. When selected, a note window switches from passive (display) to active (editing) mode, which enables the creation or importation of content into it.

UGC may be generated from user inputs received from the UGC panel 230. For example, the user may click on a note window, such as UGC window 232A, and input content into the UGC window. Alternatively, the note generation module 234 may receive a user input at other locations than the note windows. For example, the user may highlight a section of the document page and import it into a UGC window. The selected content may be imported as text-only or as a graphic object to a note window. The UGC can be imported from external sources, such as an online dictionary or encyclopedia. The user can add links to web pages and multimedia content, such as images, audio and/or video files into UGC windows, in which case custom thumbnails of the web page or the multimedia content can be created in the UGC window. This approach allows web page or the multimedia content to be accessed or launched from within the notepad window.

User-generated content in each UGC window is associated with a set of metadata unique to the creating user's activities. For instance, a UGC window's metadata typically includes information such as the type and nature of its embedded content, source and origin of its embedded content, the imported location designation within the original document, the location reference within the UGC panel 230, the time of creation, and a log to keep track of various edits over time. The metadata may also include information about the user who created the note, providing the user with explicit rights or ownership of the note. The UGC is then indexed, synchronized and referenced by the specific page of the multilayered document from which the UGC originated, and added to a UGC document structure inherited from the table of content of the document. When finished, the UGC can be integrated into the multilayered document.

FIG. 3 is a block diagram illustrating an example of multilayered digital textbook 300 according to one embodiment. It illustrates pages P1-P6 in a foundation layer 301 from an original textbook, a user-generated content layer 302, and an optional additional layer 303. The foundation textbook layer 301 contains textbook pages ingested and/or reconstructed by the digital publishing platform 102, which include all the page elements (e.g., text, graphs, charts, images, and tables), page info (e.g., pagination, arrangement, and placement) and metadata (e.g., element type, description, pricing, and conditions). The user-generated content layer 302 and the additional layer 303 are the supplemental dynamic layers that may be shared, purchased or downloaded in conjunction with the foundation layer 301.

The user-generated content layer 302 includes content uploaded to the digital publishing platform by the users and shared with other users (e.g., classmates, teachers, authors, etc.) from the user's education social connections. For example, user-generated content, such as teachers or instructors' notes created using the UGC panel 230 with reference to FIG. 2, can be incorporated into the user-generated content layer 302. User-generated content layer can be shared by friends in the user's social networks; it can also be combined with the foundation layer document to be published and put for sale on the secondary market. Multiple user-generated content layers may exist to accommodate additional user-generated content. For example, supplemental references for the foundation textbooks can be added to the foundation textbook by various users, such as students, instructors and authors. Examples of the supplemental references include study guides, exercises, examples, questions, self-testing material, and solution manuals, among other references.

Other optional additional layers may also exist, for example, advertisement content may be uploaded by advertisers or advertising agencies to the digital publishing platform. In FIG. 3, for example, content in one additional layer 303 is present for pages 1, 3 and 5. Although only three layers are shown in the example in FIG. 3, multilayered digital documents may contain fewer or more and/or different layers of content. Once a multilayered document is constructed, it is added to the content catalog 180 for possible commercialization via the secondary market publishing system 160.

### Publishing Personalized Documents

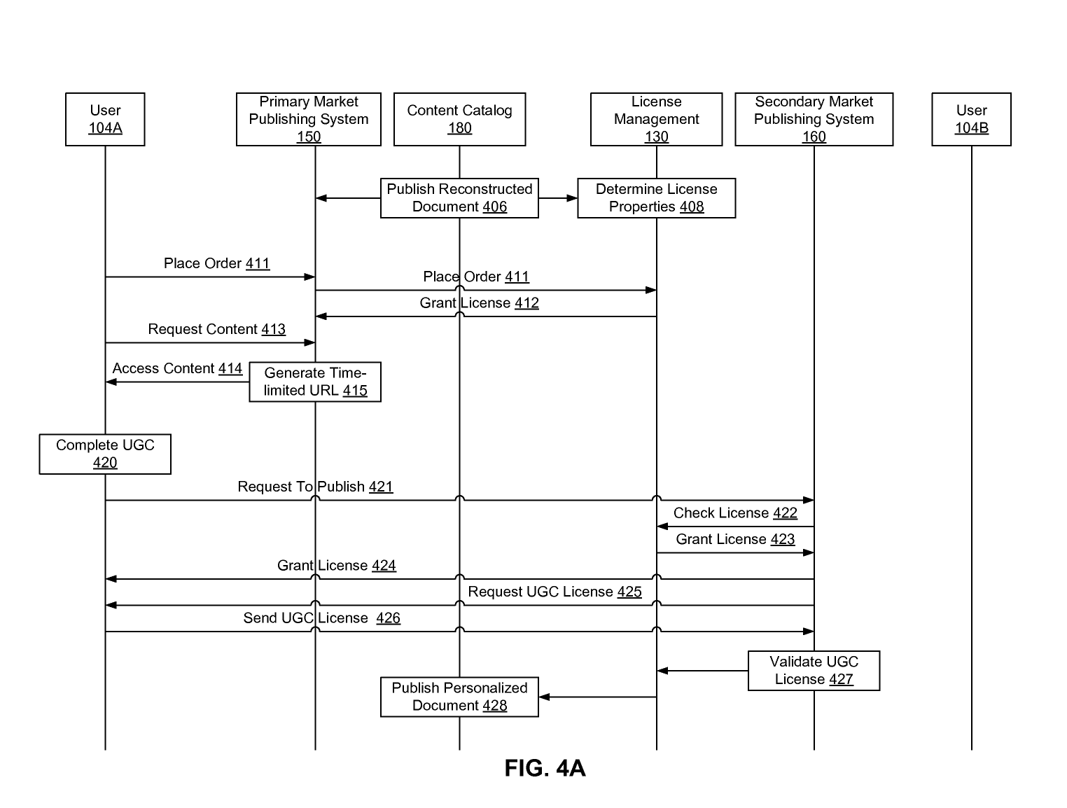

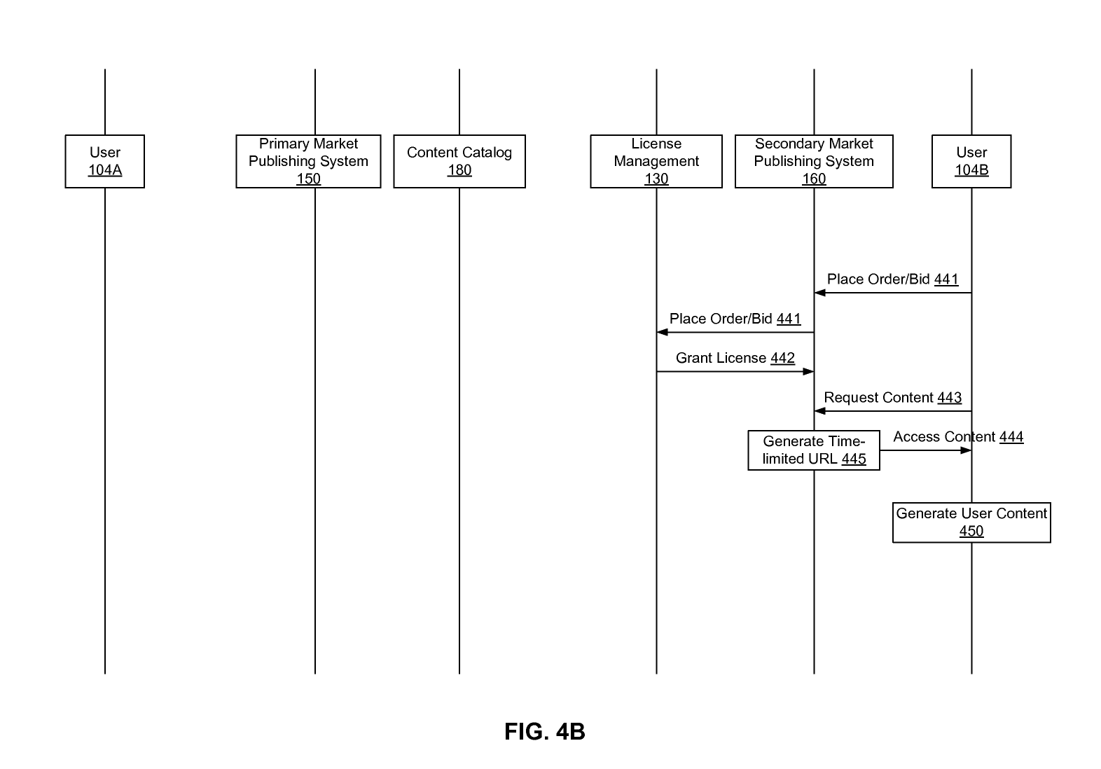

FIG. 4A is an interaction diagram illustrating publishing personalized documents on the digital publishing platform according to one embodiment. In this example, six entities are involved in the publishing of the personalized digital document: users 104A and 104B, the primary market publishing system 150 and the secondary market publishing system 160, the content catalog 180, and the license management system 130.

As a document is digitally ingested and reconstructed into markup language format by the digital publishing platform 102, the reconstructed document is stored in the content catalog 180 and published 406 by the primary market publishing system 150. The license properties of the published document are determined and managed 408 by the license management system 130. When a registered user 104A places an order 411 for the published document at the primary market publishing system 150, the order is processed by the primary market publishing system 150 and authenticated by the license management system 130. Upon authentication and validation, a license for the ordered markup language document is created 412, granting the user 104A access to the document. User 104A is then authenticated to request access 413 the digital document from the primary market publishing system 150, which generates 415 unique time-limited URLs so the user 104A may access the document pages. The user 104A can access 414 the document on a page-by-page basis using eReading browser applications running on his or her connected devices through authenticated web sessions.

While interacting with individual pages of the published reconstructed document in markup language format, the user 104A may highlight, take various notes, or generate any personal content. The user-generated or personalized content can be aggregated into a structured UGC layer to supplement the published reconstructed document (also referred to as foundation document layer). In one embodiment, the UGC layer is structured as a separate markup language document which maintains all its references to the foundation document layer and incorporates its overall table of content structure, such as title, chapter, page references and other metadata. The UGC layer can be updated and constructed dynamically by the user 104A while accessing pages of the foundation document and stored in a personal library of the user 104A along with the licensed markup language foundation document. The combination of the both foundation layer and personalized content layer, as well as their respective license properties, form a personalized document (in markup language format).

Once the personalization of the foundation document is completed 420, the user 104A can send 421 a request to the secondary market publishing system 160 for publishing the newly created personalized document to a secondary market. Since the personalized document include two or more content layers, the request for publishing the multilayered document needs to take into consideration the existing licensing properties of each layer in order to validate the publishing request. Specifically, user 104A's request for publishing the personalized document is first processed by the secondary market publishing systems 160 based on the existing license properties of the foundation document that is licensed to the user 104A.

Next, the secondary market publishing system 160 checks 422 with the license management system 130 for the license properties of the foundation document. The license properties of the foundation document, especially those transferred license properties that govern the publishing of the foundation document on the secondary market, are managed by the license management system 130 and used as a basis for either granting or denying the incoming publishing requests from the user 104A to publish the personalized markup language document on the secondary market.

When user 104A's request to publish is granted 423, the transferred license properties of the foundation document is shared 424 with user 104A for acceptance and confirmation. If the user 104A's request is denied, the platform is not granting a license for publishing the foundation document to the secondary market. Note that in this case, the user 104A may decide to publish the UGC layer as a stand-alone personal document, if still desired.

Upon granting the request to publish the foundation document with a UGC layer, the secondary market publishing system 160 then requests 425 from the user 104A, owner of the UGC layer, a confirmation of the licensing properties that are currently in effect for the particular UGC layer. The user 104A, as the owner of the personalized content in the UGC layer, specifies his or her license properties that govern the publishing and distribution of the UGC layer to the secondary market publishing system 160. In response to the request, the user 104A sends 426 the UGC layer licensing terms and conditions to the secondary market publishing system 160, which validates 427 the user-specified UGC license properties. After the validation, the personalized document is published 428 and stored in the content catalog 180.

Note that since the license properties of the foundation document may be changed and updated independently by its owner(s), the license management system 130 and the secondary market publishing system 160 always checks and validates the license properties, particularly the transferred license properties of the foundation document before requesting the UGC license properties from the user 104A. The license management system 130 and the secondary market publishing system 160 then normalizes the license properties across conditions of market territories, content protections and pricing models from both licenses. The transferred license properties of the foundation document provide a frame for the license properties of the personalized document, which defines boundaries of the UGC license properties specified by the publishing user. In other words, the UGC license properties can only further limit the transferred license properties of the foundation document. The resulting license properties that combine the UGC license properties and the transferred license properties of the foundation document are then validated to form secondary market license properties for the personalized document. At this point, the personalized document is added to the secondary market content catalog and listed as available for commercialization.

Referring to FIG. 4B, after the personalized document from the user 104A is published, the user 104B can place an order or bid 441 for the personalized document at the secondary market publishing system 160. The order is processed by the secondary market publishing system 160 and forwarded to the license management system 130. Upon validation, a license for the ordered personalized document is granted 442, authorizing the user 104b access to the personalized document. User 104B then requests to access 443 the requested document from the secondary market publishing system 160, which generates 445 time-limited URLs for the user 104B to access document content. The user 104A accesses 444 the document on a page-by-page basis using eReading browser applications running on his or her registered devices through authenticated web sessions between the user devices and digital publishing platform. Ultimately, the user 104B who has purchased the personalized document also may generate 450 his or her own UGC in addition to what was provided in the personalized document, according to the techniques described above.

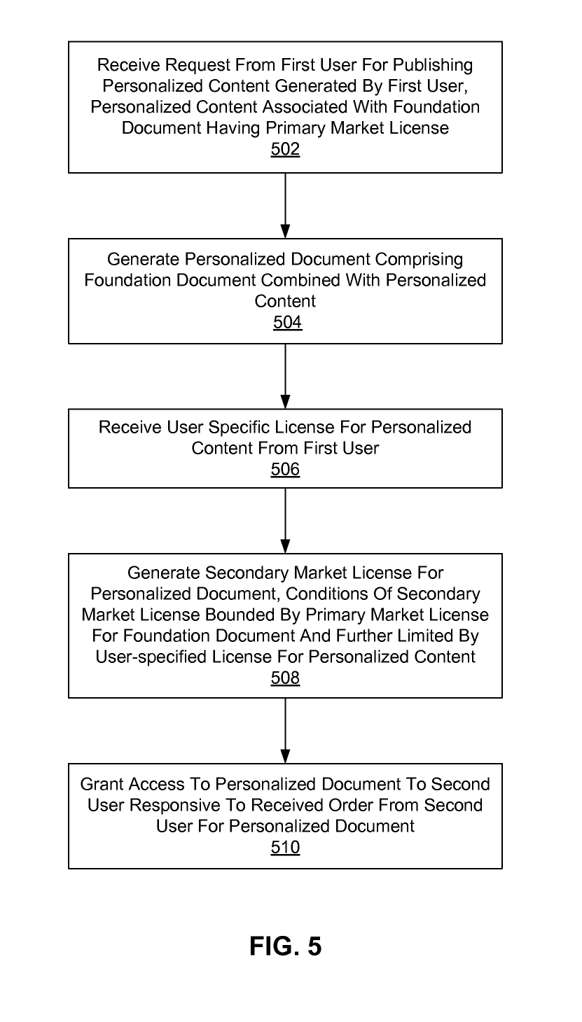

FIG. 5 is a flowchart illustrating a method for publishing a personalized document on a secondary market according to one embodiment. In the described embodiment, the steps of the method are performed by the digital publishing platform 102. Other embodiments perform the illustrated steps in different orders, and/or perform different or additional steps.

In one embodiment, the digital publishing platform receives 502 a request from a first registered user for publishing personalized content generated by the first user. The personalized content is associated with a foundation document, which is associated with a primary market license. For example, in the digital publishing platform described with reference to FIG. 4, the user 104A places an order for the published document at the primary market publishing system 150, which generates time-limited URLs for the user 104A to access document pages. The user 104A is granted a license associated with the primary market that includes terms and conditions for accessing the foundation document in the primary market. While interacting with pages of the foundation document, the user 104A may generate personalized content and later request to publish the personalized document at the secondary market publishing system 160.

In step 504, the digital publishing platform generates a personalized document comprising the foundation document combined with the personalized content. The user-generated or personalized content can be aggregated into a structured UGC layer to supplement the foundation document.

The digital publishing platform then requests and receives 506 user-specified license properties for the personalized content from the first user. As the creator and owner of the UGC, the first user may specify his or her own license properties for the distribution of the UGC. For example, the first user may decide a sale price of the personalized content, target distribution markets, pricing models for different markets, content encryption schemes, among other terms and conditions applicable to the secondary market and send these license properties to the digital publishing platform upon request.

Subsequently, the digital publishing platform generates 508 a secondary market license for the personalized document, wherein the conditions of the secondary market license are bounded by the primary market license for the foundation document and further limited by the user-specified license for the personalized content. For example, the license management system 130 and the secondary market publishing system 160 as described with reference to FIG. 4A generate a secondary market license that combines the UGC license properties and the license properties of the foundation document, so that the personalized document can be added to the secondary market content catalog and published to the secondary market.

After the personalized document is published for the secondary market, the digital publishing platform may receive an order or bid from a second user for the personalized document. The digital publishing platform grants 510 the second user access to the personalized document based on the secondary market license. For example in FIG. 4B, the user 104B can place an order or bid 441 for the personalized document after the personalized document from the user 104A is published. Upon validation, a license for the ordered personalized document is granted 442, authorizing the user 104b access to the personalized document.

### Secondary Market Models

As described in previous sections, both the primary and secondary market publishing systems function as on-line stores for the digital publishing platform services from which content catalogs are commercialized and registered users place orders. Since personalized documents are based on a combination of multiple content layers, such as a licensed foundation document with a UGC layer, a secondary market content offering is leveraging this unique combination through several distribution models, as listed below.

Fixed-price Model: In the fixed-price model, personalized documents published in the secondary market content catalog are offered to all users accessing the secondary market on-line store with a fixed price computed by the license management system. The fixed price of a personalized document is determined by the foundation document license properties and the UGC layer license properties, as well as price adjustment specified by the platform service markup.

For example, the list price of a personalized document can be quantified by the following parameters extracted from licensing properties of respective layers: “R1” the price for the foundation document, “U1” the price for the UGC Layer, and “P” the percentage for the platform service markup. Based on these parameters, the list price “L” of a licensed personalized document is computed by the platform as: L=(R1+U1)×(1+P). In this model, the list price of a personalized document on the secondary market is considered fixed because the price for each content layers are determined by its respective license holder(s) prior to publication.

Auction-based Model: In the auction-base model, personalized documents published in the secondary market content catalog are offered to all users accessing the secondary market on-line store for user bidding during a predefined time window with a base auction price computed by the license management system. In this model, the final price for a personalized document is dynamically determined by the incoming bids from participating users and base price computed by the license management system.

The following price parameters are defined and controlled by the digital publishing platform to enable a bidding process in the secondary market:
R2: foundation document price in currency unit. “R2” is set when the license holder of a document authorizes auction-based pricing for the document. “R2” may or may not equal to“R1”
U2: UGC layer price in currency unit. “U2” is set when the license holder of a document authorizes auction-based pricing for the UGC Layer. “U2” may or may not equal to “U1”
S: starting bidding price in currency unit. “S” requires that both “R2” and “U2” be set and S=R2+U2
T: length of a bidding session in time unit. “T” is set by the digital publishing platform and used to determine the length of duration for a particular bidding session
M: maximum number of licenses available per bidding sessions. “M” is set by the digital publishing platform and used to determine the number of licenses that can be assigned to a personalized document during a particular bidding session
B: single bid. “B” is defined as a conditional bid for a personalized document by a user tallied at the end of a bidding session “T” unless cancelled by the user. It is conditional because it may not be accepted at the end of a bidding session when more bids were received than the maximum number of licenses “M”
V: single bid value. “V” is defined as the currency value of a single bid “B” placed by a user. “V” typically fluctuates until set at the end of a bidding session “T”
N: actual number of bids within a bidding session. “N” is a tally of all users that placed single bid “B” for a personalized document within a particular bidding session “T”
G: aggregated value of all bids in currency unit. “G” is computed as the summation of all the bid values “V” from all the “N” bids within a bidding session “T”
H: highest bid value in currency units. “H” is the highest bid within a particular bidding session “T”
D: average bid price in currency unit. “D” is defined as the average bid value within a particular bidding session “T” and D=G/N
P: platform service markup in percentage. “P” is defined as a percentage to be applied to the computed base auction price
E: final price in currency unit. “E” is the final price of an auctioned personalized document and is computed based on the above parameters.

In one embodiment, “R2” and “U2” are set according to their respective license properties and determine the starting bid price “S”. “M” may be set to infinity, allowing the digital publishing platform to auction as many personalized document as possible without a limit. The final price of the auctioned personalized document is computed from the aggregated value “G” of all the “N” bids within a particular bidding session “T” adjusted by the platform service markup percentage “P” if applicable. In this model, the values of “R2” and/or “U2” can be set to 0 without affecting the model.

In another embodiment, the number of available licenses “M” for a personalized document is set to a specific value larger than 0. At the end of the bidding session “T”, the number of bids “A” is compared against the number of available licenses “M”. In case “M” is a smaller than “A”, all bids are ranked from the highest to lowest based on the individual bid value “V” and only the top “M” bids are accepted. Otherwise all the “A” bids are accepted. The final price of the auctioned personalized document is then computed from the aggregate value “G” of the accepted bids, adjusted by the platform service markup percentage “P” if applicable.

Social Licensing Model: In the social licensing model, personalized documents published on the secondary market are only offered to selected groups of registered users or based on their degree of separations from the owner or license holders of the personalized document. As possible connections between registered users are dynamically captured by the social network engine of the digital publishing platform and approved by the users, the outcome of the social licensing model is a dynamic social graph of user connections filtered by types, activities or preferences.

In one embodiment, a personalized document is offered by its owner or license holder to pre-existing social connections based on their degree of separation. This particular parameter is captured from the social graph of the license holder and added to the transferred license properties managed by the license management systems. For instance, the author of a UGC layer can limit the availability of the published personalized document to one or more groups of his or her existing social connections. Hence even if the personalized document is publicly listed on the secondary market, only users previously connected to the owner of the personalized document are able to order and access it.

In another embodiment, a personalized document can be made available to any potential buyers or bidders, but the license of the personalized document is differentiated based on the degree of separation from the owner or license holder's social graph. For instance, a license holder sets distinct transferred license properties per each degrees of separation, resulting in differentiated license models applied for different users depending on their closeness to the owner in the social graph. A user with a degree of separation of one from the owner or license holders are offered more distinct products and/or better services than other users with degree of separation two and more.

Event Licensing Model: In the event-based licensing model, personalized documents published on the secondary market are offered to registered users accessing the secondary market on-line store based on calendar events and/or timeframe.

In one embodiment, the transferred license properties of the personalized document include conditions that, once satisfied, trigger the changes in the license properties of the personalized document to the secondary market. The conditions may be external events scheduled to happen in the future. For example, the number of bids during a particular bidding session can trigger a modification of the transferred license properties of a published personalized document, such as switching from a particular price model to another (e.g., from auction-based to fixed-price model) or adjusting some of the transferred license properties (e.g., increasing number of available licenses or raising price).

In another embodiment, the transferred license properties of the personalized document specify one or more timeframes for the publishing of the personalized document to the secondary market. A timeframe is typically set with a calendar, such as starting date and time and ending date and time. In addition, the timeframe can also be specified as recurrent, enabling an event to reoccur periodically. For example, a personalized document can be available for purchase every morning between 9 am and 12 pm on weekdays. Access to this particular document would be disabled any other time and day.

In conclusion, personalized document publishing on the secondary market introduces new value-added content services to users of the digital education and publishing platforms. By leveraging the user-generated content and publishing it on a modern digital platform, customers at large have access to dynamic multilayered documents created and augmented by subject matter experts and other contributors. In addition, personalized document publishing provides strong incentives for users to create and distribute user-generated content based on service definitions and content licensing properties. The personalized documents extend the reach and capabilities of the digital education and publishing platform by opening a secondary market for value-added user-generated content services. In addition, a personalized document can be published on the secondary market using a combination of above price and licensing models, for example, combining fixed-price models with auction-based models or offering it selectively to the identified social connections.

### Additional Configuration Considerations

The present invention has been described in particular detail with respect to several possible embodiments. Those of skill in the art will appreciate that the invention may be practiced in other embodiments. The particular naming of the components, capitalization of conditions, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in conditions of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing conditions such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not limited to any particular programming language. It is appreciated that a variety of programming languages may be used to implement the teachings of the present invention as described herein, and any references to specific languages, such as HTML5, are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

What is claimed is:

1. A computer-implemented method for publishing personalized documents on a secondary market, the method comprising:
receiving a request from a first user for publishing personalized content generated by the first user, the personalized content associated with a foundation document having a primary market license;
generating a personalized document comprising the foundation document combined with the personalized content;
receiving a user-specified license for the personalized content from the first user;
generating a secondary market license for the personalized document, conditions of the secondary market license are bounded by the primary market license for the foundation document and further limited by the user-specified license for the personalized content; and
responsive to a received order from a second user for the personalized document, granting access to the personalized document to the second user according to the conditions of the secondary market license.

2. The method of claim 1, wherein the primary market license comprises conditions for publishing the foundation document, conditions including pricing model, authorized territories, types and levels of content protections.

3. The method of claim 1, wherein the personalized content comprises at least one selected from a group consisting of user-generated highlights, underlines, assignments, comments, notes and questions associated with pages of the foundation document.

4. The method of claim 1, wherein the generated personalized document is a multilayered document comprising a core layer of pages from the foundation document, and one or more additional layers comprising personalized content.

5. The method of claim 1, wherein the user-specified license for the personalized content comprises conditions for publishing and distribution of the personalized content.

6. The method of claim 1, wherein the primary market license comprises transferred license properties that are related to conditions for publishing and redistribution of the foundation document on the secondary market.

7. The method of claim 6, wherein the transferred license properties for a foundation document include whether the foundation document can be published to a secondary market, price and pricing model market, authorized distribution areas or territories, types and levels of the content protection for publishing the foundation document on the secondary.

8. The method of claim 6, wherein generating the secondary market license further comprising:
determining the transferred license properties from the primary market license of the foundation document;
determining license properties from the user-specified license of the personalized content; and
combining the transferred license properties from the primary market license and license properties from the user-specified license to form a secondary market license.

9. The method of claim 1, wherein granting access to the personalized document to the second user further comprises:
generating time-limited uniform resource locators (URLs) to one or more pages of the foundation document and associated personalized content; and
transmitting the generated URLs to the second user for accessing the personalized document.

10. The method of claim 1, wherein the secondary market license include conditions to distribute and offer the personalized document to targeted users among the first user's social connections.

11. A non-transitory computer-readable storage medium storing executable computer program instructions for publishing personalized documents on a secondary market, the computer program instructions comprising instructions for:
receiving a request from a first user for publishing personalized content generated by the first user, the personalized content associated with a foundation document having a primary market license;
generating a personalized document comprising the foundation document combined with the personalized content;
receiving a user-specified license for the personalized content from the first user;
generating a secondary market license for the personalized document, conditions of the secondary market license are bounded by the primary market license for the foundation document and further limited by the user-specified license for the personalized content; and
responsive to a received order from a second user for the personalized document, granting access to the personalized document to the second user according to the conditions of the secondary market license.

12. The non-transitory computer-readable storage medium of claim 11, wherein the primary market license comprises conditions for publishing the foundation document, conditions including pricing model, authorized territories, types and levels of content protections.

13. The non-transitory computer-readable storage medium of claim 11, wherein the personalized content comprises at least one selected from a group consisting of user-generated highlights, underlines, assignments, comments, notes and questions associated with pages of the foundation document.

14. The non-transitory computer-readable storage medium of claim 11, wherein the generated personalized document is a multilayered document comprising a core layer of pages from the foundation document, and one or more additional layers comprising personalized content.

15. The non-transitory computer-readable storage medium of claim 11, wherein the user-specified license for the personalized content comprises conditions for publishing and distribution of the personalized content.

16. The non-transitory computer-readable storage medium of claim 11, wherein the primary market license comprises transferred license properties that are related to conditions for publishing and redistribution of the foundation document on the secondary market.

17. The non-transitory computer-readable storage medium of claim 16, wherein the transferred license properties for a foundation document include whether the foundation document can be published to a secondary market, price and pricing model market, authorized distribution areas or territories, types and levels of the content protection for publishing the foundation document on the secondary.

18. The non-transitory computer-readable storage medium of claim 11, wherein generating the secondary market license further comprising:
determining transferred license properties from the primary market license of the foundation document;
determining license properties from the user-specified license of the personalized content; and
combining the transferred license properties from the primary market license and license properties from the user-specified license to form a secondary market license.

19. The non-transitory computer-readable storage medium of claim 11, wherein granting access to the personalized document to the second user further comprises:
generating time-limited uniform resource locators (URLs) to one or more pages of the foundation document and associated personalized content; and
transmitting the generated URLs to the second user for accessing the personalized document.

20. The non-transitory computer-readable storage medium of claim 11, wherein the secondary market license include conditions to distribute and offer the personalized document to targeted users among the first user's social connections.
